(19) United States
(12) Patent Application Publication
(10) Pub. No.: US 2018/0256422 A1
(43) Pub. Date: Sep. 13, 2018

(54) INTELLIGENT POWER WHEELCHAIR AND RELATED METHODS

(71) Applicant: Jesse Leaman, Sacramento, CA (US)

(72) Inventor: Jesse Leaman, Sacramento, CA (US)

(21) Appl. No.: 15/917,563

(22) Filed: Mar. 9, 2018

Related U.S. Application Data
(60) Provisional application No. 62/469,983, filed on Mar. 10, 2017.

(51) Int. Cl. A61G 5/10; A61G 5/04

(52) U.S. Cl. CPC A61G 5/1051; A61G 5/04; A61G 2203/70; A61G 2203/22; A61G 2203/20

(57) ABSTRACT

Methods and systems to enhance a power wheelchair with a smart or intelligent wheelchair package. In one embodiment, the package, controlled by a computer, provides at least a wheelchair navigation system to allow a person to navigate the wheelchair through indoor and outdoor locations. The package with the computer can be attachable to and detachable from the power wheelchair. A 3D mapper can make possible, for example, the use of one or more wheelchair mounted robotic arms. The robotic arms can help a user of the wheelchair raise and lower a retractable roof. A heads-up display, which can be mounted on the roof, gives the user an augmented view of the user's environment. The intelligent wheelchair package gives the user a safer and more productive life.

### CROSS-REFERENCE TO RELATED APPLICATIONS

This application claims priority of U.S. Provisional Patent Application No. 62/469,983, filed Mar. 10, 2017, and entitled “INTELLIGENT POWER WHEELCHAIR (ICHAIR) AND RELATED METHODS,” which is hereby incorporated herein by reference.

### BACKGROUND OF THE INVENTION

### Field of the Invention

The present invention relates to a wheelchair navigation system, and more particularly to a computer-controlled power wheelchair navigation system.

### Description of the Related Art

Many who cannot use their arms or legs, whether it be due to disability or disease, use a power wheelchair (PW). Since they cannot use a traditional joystick, most use alternative control systems, such as head joysticks, chin joysticks, and Sip'n puff, to control their PWs. Unfortunately, a significant population cannot even use such alternative control systems.

In recent development of smart or intelligent wheelchairs (SW), their computers are smaller and faster, sensors are cheaper and more reliable, and software algorithms have been tested repeatedly in the real world.

A SW typically includes either a standard PW base with a computer and a collection of sensors added, or a mobile robot base with a seat attached.

Pineau et al. in 2011 argued that the transition from manual to PWs is probably less important than the transition from PWs to SWs that cooperate with the user, since this latter transition may be considered as a paradigmatic rather than merely a technological shift.

Japan, faced with a growing elderly population and limited staff, such as in hospitals, has been working on a SW that could follow alongside a companion. The technologies typically are based on tracking the companion body position/orientation using a 2D Laser Range Sensor (LRS). The LRS can be set on top of a pole attached to the wheelchair at the companion's shoulder level. The SW could track the locations/orientations of the companion by applying a particle-filter framework.

Murakami et al. adopted a methodology using a robot with no a priori knowledge of the companion's destination that could move with the companion collaboratively using a destination estimation model based on observations of human daily behaviors. Takano et al. reported experimental results regarding wheelchair formations depending on circumstances such as passage width or obstacles, easing the communication with the companion depending on the formation.

Other recent approaches on SW include a heavily modified PW, that navigates autonomously on a path marked with reflective tape. The sensors in the SW detect obstacles and the reflective tape, while software controls the SW to avoid collisions and learn the path to follow.

It should be apparent from the foregoing that there is still a need for a better SW.

### SUMMARY OF THE INVENTION

One embodiment of a SW includes a computer and a SW package to allow the SW package with the computer to be mountable on most PWs, giving the corresponding user the option to choose the PW they prefer. By using range data from an infrared 3D scanner, the SW can build a 3D map of its surroundings and can navigate without the need to mark interior spaces. The SW could collect data to help create augmented reality content. Furthermore, the SW could include at least a robotic arm to allow the user to perform different functions, such as retrieving objects within the range of the arm and pressing buttons.

The SW package can be designed using 3-D CAD to be lightweight, functional, mass producible, and easily removable from a PW for travel and maintenance. The SW package can be connected to a laptop, such as via a USB cable or wirelessly. The laptop can be in turn attached to the PW with a universal mount. The SW package could include a custom-designed 3D printed plastic enclosure that houses circuit boards that control multi-color LEDs, and preprocess data from the sensors.

When activated, the SW package can be operated by the user through a human computer interface (HCI). The HCI can receive input from the user from a mouse, keyboard, single switch, joystick, game controller, sip-n-puff, tongue controller, facial tracker, voice controller, and/or thought (EEG) controller. Most operating modes have preferences allowing the user to adjust for comfort. The HCI could be clean, easy to learn, and fun to use. The HCI could also fit like a glove.

Other aspects and advantages of the present invention will become apparent from the following detailed description, which, when taken in conjunction with the accompanying drawings, illustrates by way of example the principles of the invention.

### BRIEF DESCRIPTION OF THE DRAWINGS

FIG. 1 shows one embodiment of a SW with a SW package and a computer transforming a standard PW into the SW.

FIG. 2 shows one embodiment of a close-up of a SW package, showing additional information of the positioning of lights and sensors.

FIG. 3 shows examples of different operating modes for the HCI.

FIG. 4 shows an embodiment to avoid collision.

FIG. 5 shows an embodiment to generate a 3D map.

FIG. 6 shows an embodiment to plan paths.

FIG. 7 shows an embodiment to signal emergency.

FIG. 8 shows an embodiment to dock.

FIG. 9 shows an embodiment for guide following.

FIG. 10 shows an embodiment to operate a robotic arm.

FIG. 11 shows an embodiment of a SW with a SW package, a computer, robotic arms, and a retractable roof.

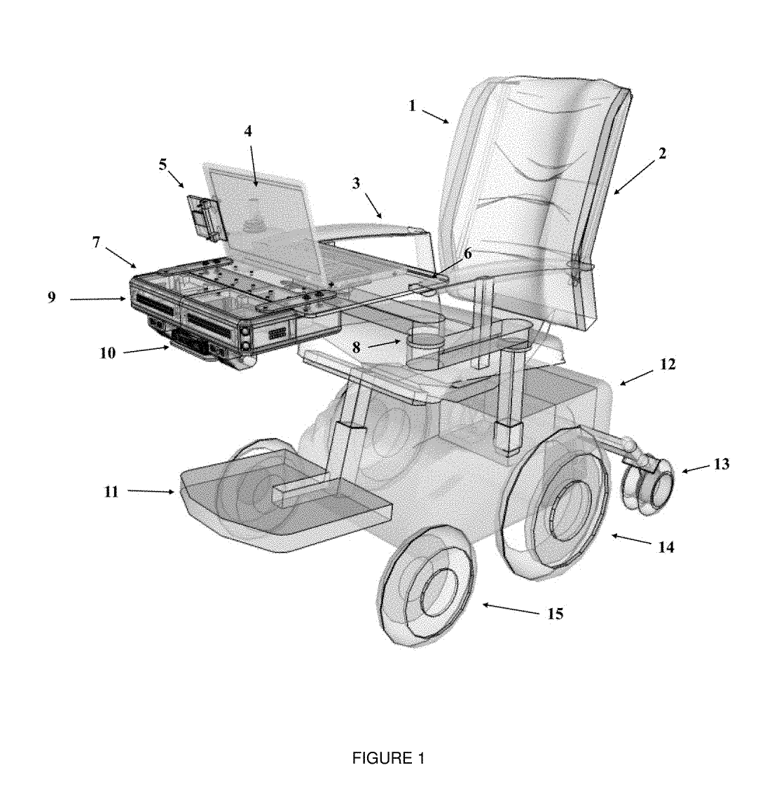

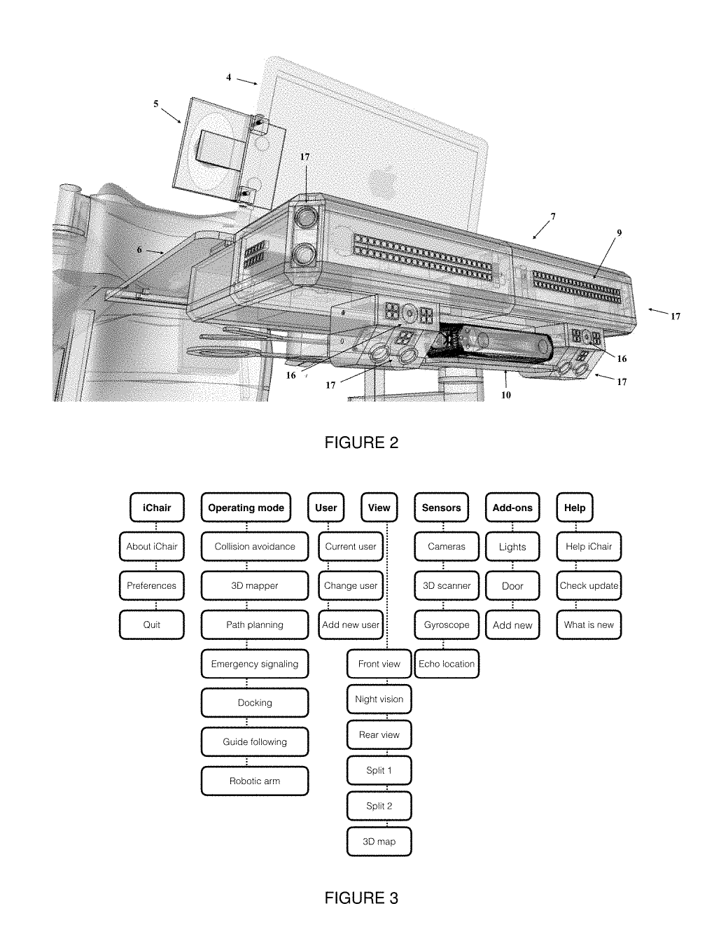

Embodiments of the invention are discussed below with reference to FIGS. 1-11. However, those skilled in the art will readily appreciate that the detailed description given herein with respect to these figures is for explanatory purposes as the invention extends beyond these limited embodiments.

### DETAILED DESCRIPTION OF THE INVENTION

To address the needs of people with mobility, sensory, and/or cognitive impairments requiring the use of a PW, one embodiment transforms the PW into a SW with at least a SW package and a computer. The SW package with the computer are easy to remove, such as for travel or maintenance.

FIG. 1 shows one embodiment of a SW with a SW package and a computer transforming a standard PW into the SW. The PW could have a backrest 1, two cupped and padded arm rests 3, a seat, a footrest 11, front 15 and rear 13 wheels for stabilization, center wheels 14, with 2×24V drive motors, and 2×12V batteries 12.

In this embodiment, the SW package includes a plastic enclosure 7 housing, for example, LED lights 9 with a controller (such as a Bluetooth controller), an infrared 3D scanner 10 with movable mount, 2 HD optical cameras 16, and 4 ultrasonic sensors for echo location. The SW package can be attached to a laptop tray 6, such as, with 4 sets of nuts and bolts. In operation, the SW package can be plugged in to a laptop 4, mounted on top of the tray 6. The laptop tray 6, the laptop 4, and SW package, can be affixed to a universal mount 8, such as with 3 movable arms. Mount 8 can be firmly bolted to the frame of the PW near the base of an arm rest 3, which could be on the left or the right up to the user of the SW.

Affixed to the backrest 1 can be a power box 2, which supplies power from the 12V batteries 12, through an inverter, to the laptop 4, and the SW package, including the LED lights 9. In addition, there can be multiple USB outlets, and a solar panel input jack. Also in the power box 2 can be a regenerative motor controller to charge the batteries 12. The SW package also can have a heatsink, or other form of cooling, and communicate data with the laptop 4 via USB cable.

When powered up, the SW package can be controlled by a multitude of input methods. The chosen method is typically a method the user feels comfortable with. In one embodiment, the input method includes a head tracking mouse 5 with dwell clicking.

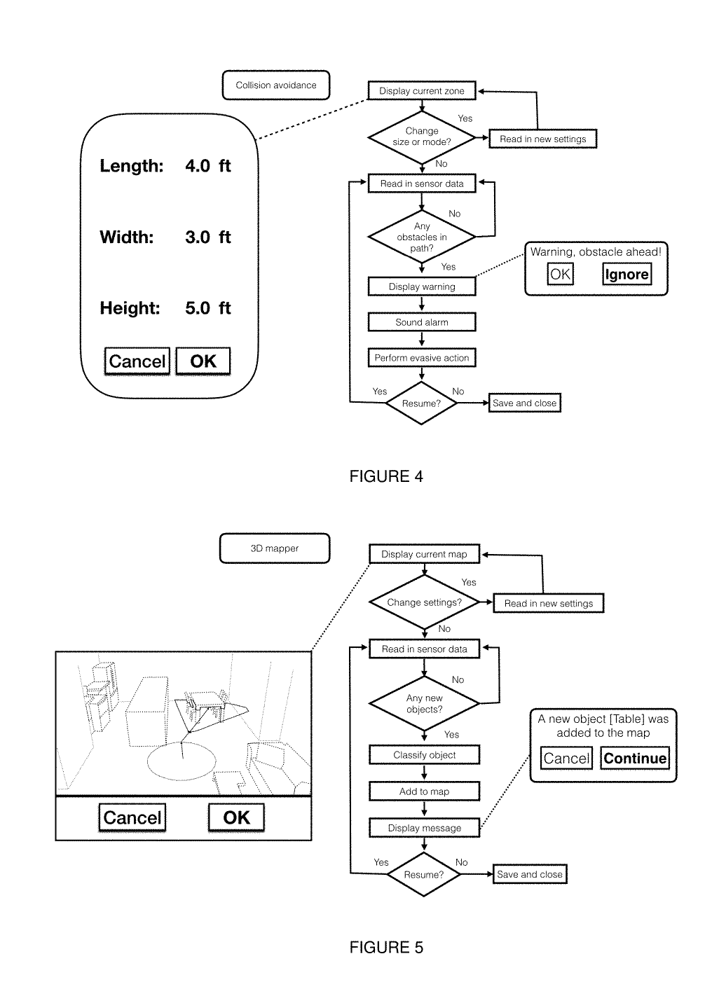

The human user interface (HCI) should be easy to learn, customize, and use. In one embodiment, there could be multiple layers of security, such as four, to prevent tampering by unregistered users. A menu bar in the HCI could include: SW package interface, Operating modes, User, View, Sensors, Add-ons, and Help. FIG. 3 shows examples of different operating modes for the HCI. The seven operating modes shown in FIG. 3 will be further explained below, for example, using FIGS. 4-10.

The SW package interface could include a dropdown menu, allowing the user to find out about the version currently loaded, read the license, set preferences, and quit the program. Program wide preferences include language, time zone, and country.

The Operating mode could include a menu to give the user the following choices: collision avoidance, 3D mapping, path planning, emergency signaling, docking, guide following, and robotic arm manipulation.

Collision avoidance can be achieved, for example, by monitoring signals from the 4 ultrasonic sensors or range finders, and the infrared 3D scanner 10 that collects, for example, 640×640 pixel images, at a rate of 60 frames per second. The range data generated can be used to warn the user if the SW is getting too close to an obstacle. If semi-autonomy is the preference, the SW package could swerve or stop to avoid collision.

In one embodiment, the SW package gives the user the option to set the size of the avoidance zone, i.e. how close to objects the SW can get, and when alerts should be made. FIG. 4 shows an embodiment to avoid collision. In some instances, the zone size can be reduced, such as in passing through a doorway, or using an elevator. By default, the zone can be set to be 6 inches beyond the PW's footprint, and the collision avoidance mode can remain operational when other Operating modes are engaged.

The SW package could analyze the collision avoidance data and video data from the 2 side by side mounted HD optical cameras 16, and use, for example, a classification algorithm to create a library of detected objects. Besides being able to identify stationary objects, the SW package could track moving objects, and predict their trajectory based on, for example, motion dynamics and/or past behaviors. Objects the SW package could track include traffic signs, written text, and people and at least some of their intentions. The more data the SW package collects, the more refined the 3D map becomes, and the easier it is to identify new or dynamic objects.

In one embodiment, the 3D mapping mode uses stationary objects detected to build a precision 3D map. FIG. 5 shows an embodiment to generate a 3D map. For indoor localization, the SW package could integrate data from the various sensors, including, for example, the HD optical cameras 16, the infrared 3D scanner 10, and a gyroscope, to generate a 3D map of the environment. The SW package can perform navigational guidance based on localization, and can identify objects, such as those within reach of one or more robotic arms. This localization can be relative to stationary objects.

In one embodiment, once the SW travels to an outdoor environment, relative localization may not be practical. The SW package can perform absolute positioning based on latitude, longitude and altitude. For outdoor localization, the infrared 3D scanner's range can be reduced by the glare of the sun. Also, GPS may not always be reliable and accurate (such as to ±2 ft), especially in tree covered environments. In one approach, the SW package uses motion sensors to improve location accuracy (odometry-enhanced) in, for example, environments where GPS signals are very weak or blocked. Also, the ultrasonic sensors can continue to help avoid collisions, such as in areas when the infrared data is compromised. Data from an overhead drone can also be used to help generate a 3D outdoor map.

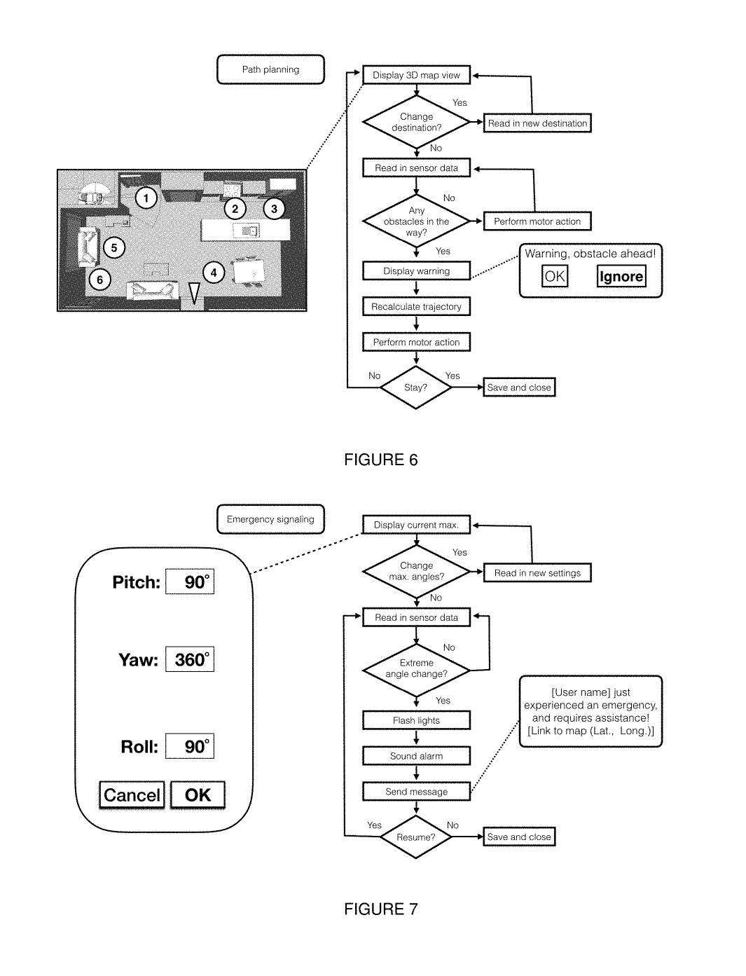

With a 3D map generated, the SW package can assist the user to plan a path to travel by selecting from destinations on the screen of the laptop. FIG. 6 shows an embodiment for a path planning mode. The SW package could provide navigational assistance, like arrows on the display and/or verbal cues. The SW package could provide semi-autonomous assistance such as collision avoidance, and haptic steering. More comprehensive autonomous navigation could require precision to, for example, ±2 inches localization, object identification with gesture recognition for human obstacles, and trajectory prediction for moving objects.

The SW package also could include an emergency notification system for an emergency signaling mode. FIG. 7 shows an embodiment for a emergency signaling mode. For example, if the SW tips back, or over to one side, as shown by the gyroscope, the SW provides different responses. For example, the LED lights 9 can flash, such as in blue and white; there could be an audible siren; and/or an alert notification could be sent to predetermined contacts of the user, calling for assistance.

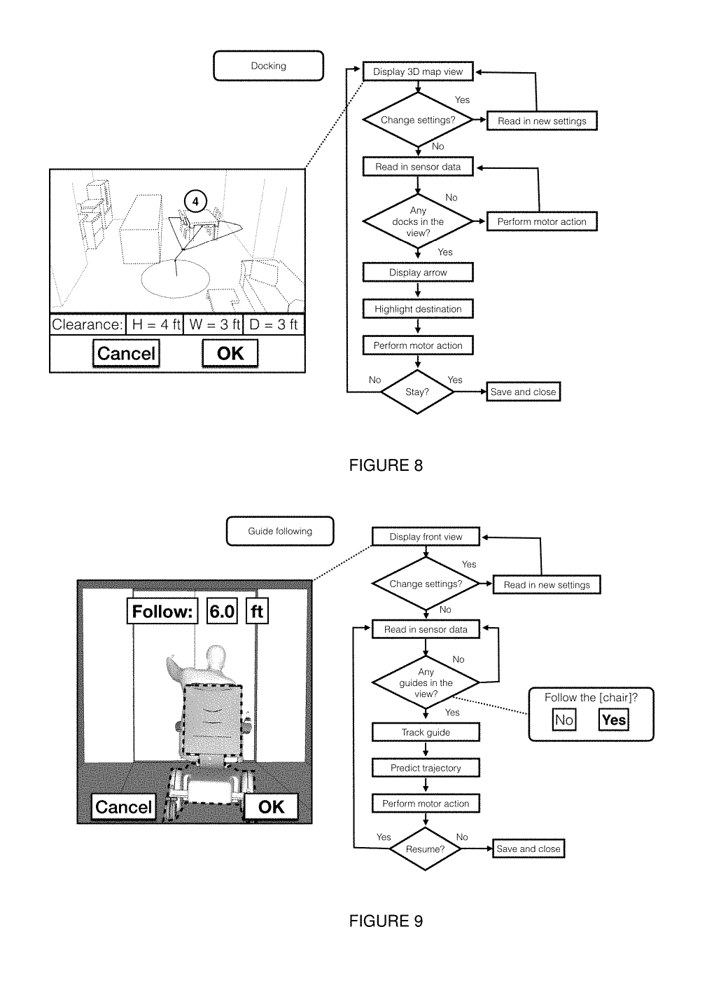

PW users typically ‘park’ or ‘dock’ in a few special locations that share certain characteristics. For example, locations should have a certain obstacle free volume, such as a volume 4 ft high, 3 ft wide, and 2 ft deep for desks and tables. Docking locations may be identified by signs and may be associated with other objects and times. For example, plates and utensils mark locations on a table, where food would be found at meal time. The user could select from destinations on a 3D map, and receive navigational assistance, like arrows on the display and/or verbal cues. FIG. 8 shows an embodiment for a docking mode. Docking typically occurs indoors, and over short distances, using reliable full autonomous mode, easily assimilated by the user.

Guide following can be especially useful when multiple SW are traveling together, like in a hospital, rehab, or retirement community. FIG. 9 shows an embodiment for a guide following mode. Controlling the SWs, while maintaining formation, can be done by plotting a path p defined by, such as, the predicted trajectory of a guide. The path for each SW (p1, p2, . . . ) can be a small distance from p. This mode can be fully autonomous and can be useful for users, who either do not like driving or lack the cognitive ability to plan a safe trajectory.

One embodiment includes a user menu, which can show the current user first, followed by any other authorized users like parents, caregivers, etc. At the bottom of the menu could be a tab to add a new user, who may need to enter at least 1 security code, and complete a tutorial to use the SW package, before the new user can be added.

One embodiment includes the selection of a view determining what, and in which way, information can be displayed on a screen of the display. A forward view can display a video captured with one of the front facing HD cameras. A night vision view can display infrared scans, which can provide range data up to, for example, 22 feet, even in the absence of visible light. A rearview can display video from a rear pointing camera, which could be a USB camera, and which can be of a lower resolution. There could be a mosaic of the 3 views discussed above, known, for example, as Split 1. The forward view could occupy most of the screen space. Split 2 can be the same as Split 1, except the rearview is emphasized. There could also be a 3D map displaying the latest map of the SW's current surroundings.

There could be a sensor menu, allowing the user to adjust the settings and data flow from each of the sensors. Adjustable parameters for the cameras and scanner can include resolution and frame rates. There could be an echo location tab showing a diagram of the locations of the sensors, and their operating status. There could also be a gyroscope tab showing a diagram of the SW from 3 perpendicular angles, indicating Pitch, Roll, and Yaw.

There could be add-ons, which can be a piece of technology/device that the laptop communicates with via, for example, Bluetooth. As discussed, lights can be previously included, and other devices can be added. Other devices include, for example, a door opener, different speakers, and custom solutions, such as an electronic valve that allows the user to independently empty his/her urine bag.

In one embodiment, the SW package includes a help menu, which could allow the user to get answers to frequently asked questions, check for updates, and find out what is new in the current version of the SW package.

Note that a person who cannot use his/her arms is heavily reliant on his/her caregiver for eating and drinking, handling items, and communicating with others, especially in large groups. The addition of robotic arms to the SW package could allow various daily living activities to be performed independently, which, in turn, could reduce the burden on caregivers, and boost spirits of the user, and his loved ones alike.

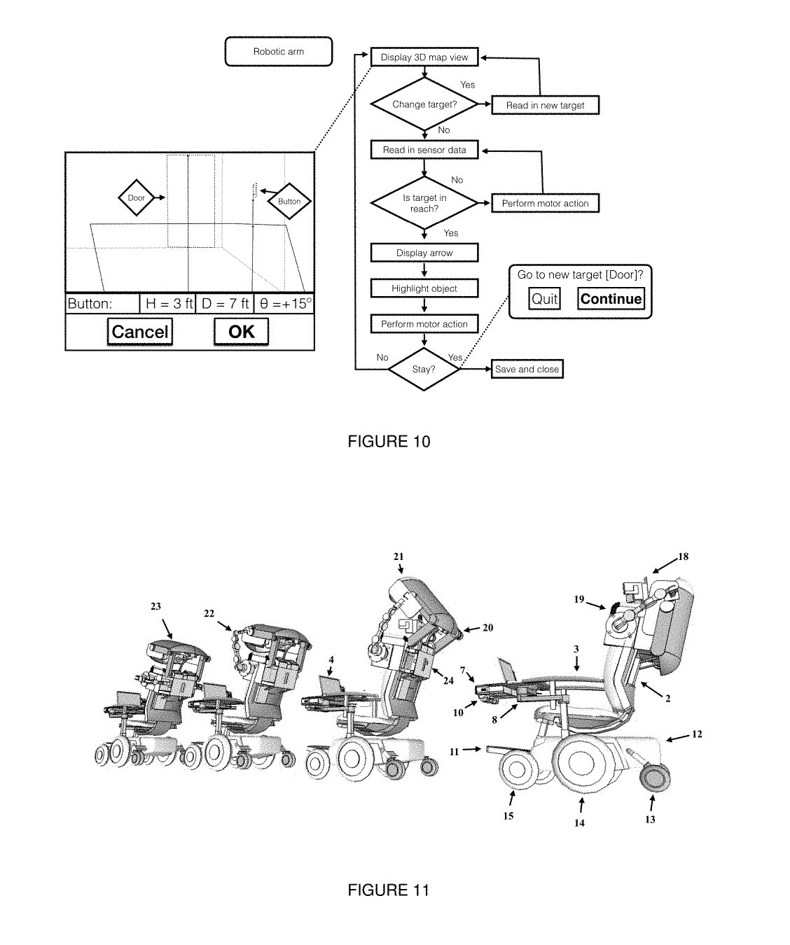

In other embodiments, the SW package's 3D mapper could provide the location of objects within reach of robotic arms. FIG. 10 shows an embodiment for a robotic-arm manipulation mode to operate one or more robotic arms. This could give the user the following abilities:

1. Eating: retrieve a piece of food and hold it in the user's biting range. Return leftovers to a bowl.

2. Drinking: retrieve a mug, hold it in sipping range, and return the mug to a table.

3. Retrieve: retrieve a bag and put it into a storage container built into, for example, a retractable roof of the SW.

4. Stamp: take a stamp from a container built, for example, into the retractable roof, stamp an insignia, and date on a letter, and return stamp to the container.

5. Nonverbal communication: select from a series of preprogrammed moves including: waving, pointing, celebrating a touchdown, and doing a robot dance.

6. Pressing buttons: like pressing a door opener button.

7. Raise and lower a retractable roof with a heads-up display for the SW.

FIG. 11 shows different stages of one embodiment of a SW with a SW package, a computer, robotic arms, and a retractable roof having a heads-up display. The head joystick 18 controlling the SW can be outfitted with a bracket 19 where robotic arms 22 could be mounted. The arms could raise and lower the roof support struts 20, with the heads-up display 21 rotating into view. The lid 23 is typically made of light weight, hard material, such as carbon fiber. The back of the arm mount 24 could have storage space and hold the hands when they are on standby.

Different embodiments of the above, such as 3D mapping, relative indoor localization, and absolute outdoor localization, can be of value for location-based devices, especially those with manipulator arms to perform, for example, an autonomous task in close quarters. Applications include, for example, bridge and sewer maintenance, mining, disaster relief, oil and gas exploration, bomb disposal, and planetary exploration. Technological advances will further benefit SW users and the SW research community.

The various embodiments, implementations and features of the invention noted above can be combined in various ways or used separately. Those skilled in the art will understand from the description that the invention can be equally applied to, or used in, other various different settings with respect to various combinations, embodiments, implementations or features provided in the description herein.

The invention can be implemented in software, hardware or a combination of hardware and software. A number of embodiments of the invention can also be embodied as computer readable code on a computer readable medium. The computer readable medium is any data storage device that can store data, which can thereafter be read by a computer system. Examples of the computer readable medium include read-only memory, random-access memory, CD-ROMs, magnetic tape, optical data storage devices, and carrier waves. The computer readable medium can also be distributed over network-coupled computer systems so that the computer readable code is stored and executed in a distributed fashion.

Numerous specific details are set forth in order to provide a thorough understanding of the invention. However, it will be understood by those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

Also, in this specification, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1. An apparatus for a power wheelchair comprising:
at least one sensor;
at least one output device;
a user-input device; and
a plastic enclosure,
wherein the apparatus is configured to be controlled by a computing device to provide at least a wheelchair navigation system, and
wherein the apparatus is configured to be mountable onto the power wheelchair.

2. The apparatus as recited in claim 1, wherein the apparatus is configured to be operable as at least one of the following: collision avoidance, emergency signaling, and rear viewing.

3. The apparatus as recited in claim 1, wherein the apparatus is configured to operate with relative localization.

4. The apparatus as recited in claim 1, wherein the apparatus includes a 3D mapper, allowing for autonomous navigation, without the need for a markup path.

5. The apparatus as recited in claim 4, wherein the 3D mapper is configured to allow the use of at least a wheelchair mounted robotic arm.

6. The apparatus as recited in claim 5, wherein the apparatus includes robotic arms that raise and lower a roof.

7. The apparatus as recited in claim 6, wherein the apparatus includes a retractable roof, allowing the use of a heads-up display.
